(19) United States
(12) Patent Application Publication
(10) Pub. No.: US 2022/0223868 A1
(43) Pub. Date: Jul. 14, 2022

(54) ANODE-LESS LITHIUM-SULFUR (LI-S) BATTERY WITH LITHIUM METAL-FREE CURRENT

(71) Applicant: University of North Texas, Denton, TX (US)

(72) Inventors: Wonbong Choi, Coppell, TX (US); Juhong Park, Denton, TX (US); Sungyong In, Denton, TX (US)

(21) Appl. No.: 17/576,632

(22) Filed: Jan. 14, 2022

Related U.S. Application Data
(60) Provisional application No. 63/137,712, filed on Jan. 14, 2021.

(51) Int. Cl. H01M 4/58; H01M 4/583; H01M 4/04; H01M 4/66

(52) U.S. Cl. CPC H01M 4/5815; H01M 4/583; H01M 4/661; H01M 4/0471; H01M 4/0426

(57) ABSTRACT

The present disclosure describes an “anode-less” solid state lithium battery (e.g., a solid-state battery that does not include a lithium metal anode). For example, the battery may include, in place of a conventional anode, a lithium metal-free current collector (e.g., a current collector that does not include lithium metal, such as one that includes copper, copper materials, aluminum, or a lithium alloy) that is coated with at least one layer of a two-dimensional (2D) transition metal dichalcogenide (TMD) material. A solid state electrolyte material may be disposed within the battery between the layer(s) of 2D TMD material and a cathode that includes a matrix structure of carbon materials and sulfur or lithium sulfide particles. A method of forming such a battery is also described. 2D TMD coated lithium metal-free current collectors and solid-state electrolytes provide for reduced lithium dendrite growth, reduced weight, reduced cost, and significant performance improvements to batteries.

### CROSS-REFERENCE TO RELATED APPLICATIONS

The present application claims the benefit of priority from U.S. Provisional Application No. 63/137,712 filed Jan. 14, 2021 and entitled “ANODE-LESS SOLID STATE LI-S BATTERIES,” the disclosure of which is incorporated by reference herein in its entirety.

### TECHNICAL FIELD

The present disclosure relates generally to electrochemical energy storage systems and methods for manufacturing the same. Specifically, the present disclosure provides for manufacturing and using two-dimensional (2D) transition metal dichalcogenides (TMDs) to coat metals other than lithium for use in “anode-less” electrochemical energy storage systems.

### BACKGROUND

There is a growing awareness that current lithium-ion battery technologies are reaching their limits in terms of storage and energy capabilities. However, there is still increasing demand for higher energy storage and longer lasting devices. For example, prevalent battery-based appliances (e.g., electric vehicles, mobile computing and telecommunications devices, aerospace transportation, specialized unmanned vehicles, etc.) require higher energy storage over conventional lithium-ion battery systems. This has challenged the research community to search for next-generation battery systems.

Lithium (Li) metal has been known as the “hostless” material to store Li ions (Li+) without the need for using intercalating and/or conducting scaffold techniques. For this reason, Li metal electrodes exhibit high theoretical specific capacity (˜3860 mAh g⁻¹) and low redox potential (−3.04 V); thus, they are often regarded as the best choice to use for manufacturing/fabricating anodes for next-generation rechargeable Li batteries. However, Li metal anodes exhibit properties that cause multiple practical issues which inhibit their use. These properties are often associated with uncontrollable dendrite formation during repeated Li deposition/dissolution processes, which can lead to short circuiting the battery and potential overheating and fire.

Among various electrochemical energy storage systems, lithium-sulfur (Li—S) batteries have potential to be a next generation rechargeable battery because of their high theoretical energy density (approximately 2600 Wh kg⁻, which is five times higher than the approximately 387 Wh kW' energy density of the conventional Li-ion batteries), low cost, and the natural abundance of sulfur and other chalcogens (e.g., selenium, tellurium, etc.). As an example, an Li—S battery may include an anode, cathode, separator, electrolyte, negative terminal, positive terminal, and casing. The anode may include a Li electrode coated with at least one layer of two-dimensional (2D) material, and the cathode may include sulfur powder as a sulfur electrode and/or a composite with carbon structures (e.g., carbon nanotubes (CNTs), graphene, porous carbons, free-standing three-dimensional (3D) CNTs, etc.). The separator may include polypropylene (PP), polyethylene (PE), or the like, and the electrolyte may include any number of electrolyte solutions (e.g., aqueous, non-aqueous, etc.) which may allow for transporting Li ions between the cathode and the anode. Example structures and operations of Li—S batteries are discussed in further detail in U.S. patent application Ser. No. 16/482,372, which is incorporated by reference herein.

While the low cost and abundance of sulfur make the concept of Li—S batteries alluring, there are several issues that generally prevent the widespread development of Li—S batteries. For example, sulfur is an insulating material, which provides for poor utilization of the active material and hinders electron transfer during the charge/discharge process. In addition, during the discharge process, Li may react with sulfur to form higher-order soluble polysulfides at the cathode, which creates shuttling of polysulfide between the anode and cathode during the cycling process. The shuttling effect may increase the internal resistance of the battery and contribute to capacity fading. Further, the formation of uncontrolled dendrites resulting from uneven deposition of Li metal may cause safety problems at higher C-rates as well as continuous evolution of a porous Li metal structure, which may lead to corrosion of the Li metal. While some approaches for Li—S batteries have been developed, issues of decreased cell efficiency and increased capacity fading still affect the performance of Li—S batteries when used with an Li anode. To address some of these issues, research has begun into using solid-state electrolytes (SSEs) in Li—S batteries. Although several types of SSEs have been tested in this context, issues of low ion flow, low Coulombic efficiency, and extensive dendrite growth have so far prevented widespread use of SSEs in Li—S batteries.

### SUMMARY

Aspects of the present disclosure provide systems, devices, and methods of manufacturing lithium metal-free current collectors coated with two-dimensional (2D) transition metal dichalcogenide (TMD) materials (e.g., MoS₂, MoSe₂, MoWeTe₂, BN—C, etc.) for use in place of lithium metal anodes in lithium-sulfur (Li—S) batteries. For example, instead of a typical lithium metal anode, a battery of the present disclosure may include a metal (e.g., aluminum or copper, as non-limiting examples), carbon material, or alloy (e.g., lithium alloy) current collector that operates as an anode for the battery. The current collector is “lithium metal-free,” such that the current collector does not include lithium metal (e.g., the current collector is formed from a different metal or from an alloy of lithium or another metal or from carbon materials and is not formed from metallic lithium). The 2D TMD material(s) act as a protective layer for the current collector to reduce or prevent lithium dendrite growth and to provide significant performance improvements as compared to other Li—S batteries.

In some aspects, one or more layers of 2D TMD material may be formed on a lithium metal-free current collector by deposition techniques such as sputtering or evaporation. The thickness of the layer(s) of the 2D TMD material may be controlled by controlling the deposition time, preferably such that the 2D TMD material has a thickness between 1 nanometer (nm) to 1000 nm. A dense, solid-state electrolyte (SSE) layer may be formed on the 2D TMD material. In some implementations, the SSE layer includes one or more layers of 2D TMD materials, preferably having a thickness between 10 nm and 200 micrometers (μm). Alternatively, the SSE layer may include other types of SSEs, such as garnet structures, perovskite structures, thiosilicate lithium super ionic conductor (thio-LISICON) materials, or solid polymer composite electrolytes, as non-limiting examples. A cathode may be provided in direct contact with the SSE layer. The cathode may include carbon material and sulfur powder or lithium sulfide (Li₂S) powder. In some implementations, the carbon material includes structures (e.g., carbon nanotubes (CNTs) or the like), carbon nanofibers, or carbon powder that form a conductive matrix structure, and the sulfur powder or the Li₂S powder is diffused within the conductive matrix structure.

The present disclosure describes systems, devices, and methods of manufacture of electrochemical energy storage systems that provide benefits compared to conventional Li—S batteries. For example, an anode-less battery described herein includes an Li-metal-free current collector coated with at least one layer of 2D TMD material instead of a conventional Li-metal anode. The protective layer(s) of 2D TMD material reduce or prevent Li-dendrite growth due to the 2D TMD material's high ion transport and uniform Li-ion deposition properties. Reducing or preventing Li-dendrite growth reduces corrosion of the battery and prevents (or reduces the likelihood of) safety issues at higher C-rates. Because the current collector is Li-metal-free, the source of Li-ions within the battery is Li₂S and polysulfides in the cathode and/or the pre-lithiated SSE layer. Due to trapping of polysulfides within a carbon matrix structure of the cathode, the polysulfides are converted faster, which decreases polysulfide loss due to diffusion. This decrease in polysulfide loss extends the cycle life and improves the energy density of the battery, thereby providing significant performance improvements as compared to other Li—S batteries. Additionally, using an Li-metal-free current collector instead of a conventional lithium anode reduces the weight and cost of the battery.

In a particular aspect, a battery includes a lithium metal-free current collector coated with at least one layer of a two-dimensional (2D) transition metal dichalcogenide (TMD) material. The battery also includes a cathode. The battery further includes a solid-state electrolyte in physical contact with both the at least one layer of the 2D TMD material and the cathode.

In another particular aspect, a method includes providing a lithium metal-free material. The method also includes depositing an interlayer material on the lithium metal-free material. The method includes depositing at least one layer of a 2D TMD material on the interlayer material. The method further includes depositing a solid-state electrolyte on the at least one layer of the 2D TMD material.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 illustrates a cross-sectional view of an example of a lithium metal-free current collector coated with at least one layer of a two-dimensional (2D) transition metal dichalcogenide (TMD) material according to one or more aspects;

FIG. 2 illustrates views of an example of a cathode according to one or more aspects;

FIG. 3 illustrates an example of a battery system implemented with a 2D TMD-coated lithium metal-free current collector according to one or more aspects;

FIG. 4 depicts an illustrative schematic for fabricating a 2D TMD-coated lithium metal-free current collector according to one or more aspects;

FIG. 5 depicts another illustrative schematic for fabricating a 2D TMD-coated lithium metal-free current collector according to one or more aspects;

FIG. 6 is a flow diagram illustrating an example of a method for manufacturing a battery system with a 2D TMD-coated lithium metal-free current collector according to one or more aspects;

FIG. 7A depicts an illustrative schematic for a symmetric cell test during discharge cycling according to one or more aspects;

FIG. 7B illustrates scanning electron microscopy (SEM) images of components of the symmetric cell test after discharge cycling according to one or more aspects;

FIG. 8A depicts an illustrative schematic for a symmetric cell test during charge cycling according to one or more aspects;

FIG. 8B illustrates SEM images of components of the symmetric cell test after charge cycling according to one or more aspects; and

FIG. 9 illustrates images of a 2D TMD-coated, lithium metal-free current collector after multiple discharge cycles according to one or more aspects.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

Aspects of the present disclosure provide systems, devices, and methods of manufacturing “anode-less” electrochemical energy storage systems, such as lithium-sulfur (Li—S) batteries. As referred to herein, an anode-less battery is a battery that omits a metallic lithium anode that is included in conventional Li—S batteries. Instead of the metallic lithium anode, a battery in accordance with one or more aspects includes a lithium metal-free current collector coated with two-dimensional (2D) transition metal dichalcogenide (TMD) materials, which provides performance improvements compared to conventional Li—S batteries that include metallic lithium anodes.

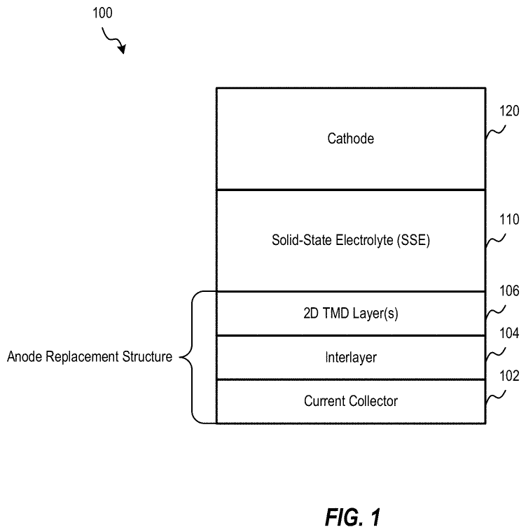

Referring to FIG. 1, an example of a lithium metal-free current collector coated with at least one layer of a 2D TMD material according to one or more aspects is shown as an electrochemical energy storage system 100. In some implementations, the electrochemical energy storage system 100 is included or integrated in a battery, such as a Li—S battery. For example, the electrochemical energy storage system 100 may be part of an anode-less Li—S battery or an Li—S battery having a lithium metal-free anode. Although described as an anode-less Li—S battery, in some implementations the battery may not include any lithium, and thus may also be referred to as an anode-less solid state battery that is similar to an Li—S battery. As shown in FIG. 1, the electrochemical energy storage system 100 includes a current collector 102, an optional interlayer 104, one or more layers of 2D TMD material (referred to herein as the 2D TMD layers 106), a solid-state electrolyte (SSE) 110, and a cathode 120. A second current collector (not shown) may be coupled to the cathode 120.

Conventional lithium-ion batteries (LIBs) typically include two electrodes (e.g., an anode and a cathode), a separator disposed between the two electrodes, an electrolyte that is in contact with (and may surround portions of) the two electrodes, and two current collectors. Each current collector is coupled to a respective electrode and operates as an electrical conductor between the respective electrode and external circuits, as well as a support for any materials that coat the respective electrode. The anode of LIBs is typically formed of metallic lithium, and the cathode is formed of a conductive material. The current collectors are typically formed of metal, such as copper or aluminum, in order to conduct electricity between the respective electrode and external circuits powered by the LIB.

In contrast to many conventional LIBs, the electrochemical energy storage system 100 is anode-less (e.g., the electrochemical energy storage system 100 does not include an anode coupled to the current collector 102). Instead of being coupled to a metallic lithium anode, the current collector 102 (in conjunction with one or more other elements) may operate as an anode and a current collector by conducting electricity from external circuits to the electrochemical energy storage system 100 for storage or conducting stored energy from the electrochemical energy storage system 100 to external circuits. The current collector 102 is a lithium metal-free (Li-metal-free) current collector, also referred to as a metallic lithium-free (metallic-Li-free) current collector. To illustrate, the current collector 102 does not include lithium metal (e.g., metallic lithium). In some implementations, the current collector 102 may include a different metal, such as copper or aluminum (e.g., the current collector 102 may include a copper metal collector or an aluminum metal collector), as non-limiting examples. In some other implementations, the current collector 102 may include metallic alloys. For example, the current collector 102 may include lithium alloy (e.g., an alloy of lithium instead of metallic lithium), such that the current collector 102 is includes a lithium alloy collector. In some other implementations, the current collector 102 may include carbon materials.

The 2D TMD layers 106 may coat, or be disposed on, the current collector 102. For example, the 2D TMD layers 106 may be formed by a deposition process, such as sputtering, evaporation, or electrochemical deposition, as non-limiting examples. The 2D TMD layers 106 may include one or more 2D TMD materials, such as molybdenum disulfide (MoS₂), tungsten disulfide (WS₂), molybdenum ditelluride (MoTe₂), molybdenum diselenide (MoSe₂), tungsten diselenide (WSe₂), titanium disulfide (TiS₂), tantalum disulfide (TaSe₂), niobium diselenide (NbSe₂), nickel ditelluride (NiTe₂), boron nitride (BN), composites thereof, or the like, or these compounds (or alloys) combined with one or more additional elements, such as molybdenum tungsten disulfide (MoWS₂), molybdenum tungsten ditelluride (MoWTe₂), molybdenum sulfur ditelluride (MoSTe₂), molybdenum sulfur diselenide (MoSSe₂), molybdenum rhenium disulfide (MoReS₂), niobium tungsten disulfide (NbWS₂), vanadium molybdenum ditelluride (VMoTe₂), tungsten sulfur diselenide (WS Se₂), tungsten tellurium disulfide (WTeS₂), tin selenium disulfide (SnSeS₂), or the like. It is appreciated that different materials may provide for different performance. As a non-limiting example, MoS₂ provides strong adhesion to Li metal; it also is readily transformed to metallic phase to reduce impedance. The 2D TMD layers 106 may include a single layer or multiple layers of 2D TMD material. If the 2D TMD layers 106 include multiple layers, each layer of the 2D TMD layers 106 may include the same type of 2D TMD material or at least one layer may be a different type of 2D TMD material than at least one other layer. In some implementations, the 2D TMD layers 106 may have a thickness between approximately 1 nanometer (nm) and approximately 1000 nm, which may be controlled by controlling a deposition duration, as further described herein. Because the 2D TMD layers 106 coat (or are disposed on) the current collector 102 and therefore prevent direct contact between the current collector 102 and the SSE 110, the 2D TMD layers 106 may act as a protective layer for the current collector 102.

In some implementations, the optional interlayer 104 is included and is disposed between the current collector 102 and the 2D TMD layers 106. In implementations in which there are multiple layers in the 2D TMD layers 106, the interlayer 104 is disposed between the current collector 102 and a first deposed layer (e.g., a bottom layer in the orientation shown in FIG. 1) of the 2D TMD layers 106. In some implementations, the interlayer 104 includes metal particles or one or more thin films, such as thin films of magnesium (Mg), silver (Ag), zinc (Zn), aluminum (Al), carbon (C), silicon (Si), tin (Sn), lead (Pb), antimony (Sb), bismuth (Bi), molybdenum (Mo), tellurium (Te), tantalum (Ta), titanium (Ti), or the like. The interlayer 104 may provide additional protection for the current collector 102 (e.g., by providing an additional layer between the current collector 102 and the SSE 110) and/or may promote adhesion with the 2D TMD layers 106. The combination of the current collector 102, the 2D TMD layers 106, and optionally the interlayer 104, may be referred to as an anode replacement structure, or a lithium metal-free anode.

The SSE 110 may be disposed on the 2D TMD layers 106, as shown in FIG. 1. The SSE 110 may be deposited using sputtering, evaporation, or electrochemical deposition, as non-limiting examples, and, prior to deposition, the SSE 110 may include an aqueous electrolyte or a non-aqueous electrolyte. In some implementations, the SSE 110 may include one or more layers of 2D TMD material. For example, at least a portion of the SSE 110 may include MoS₂, WS₂, MoTe₂, MoSe₂, WSe₂, TiS₂, TaSe₂, NbSe₂, NiTe₂, BN, composites thereof, or the like, or these compounds (or alloys) combined with one or more additional elements, such as MoWS₂, MoWTe₂, MoSTe₂, MoSSe₂, MoReS₂, NbWS₂, VMoTe₂, WSSe₂, WTeS₂, SnSeS₂, or the like. The 2D TMD material included in the SSE 110 may be the same as or different than the 2D TMD material included in the 2D TMD layers 106. As a non-limiting example, the 2D TMD layers 106 may include MoS₂, and the SSE 110 may include MoTe₂. In some implementations in which the SSE 110 includes one or more layers of 2D TMD material, the SSE 110 may have a thickness between approximately 10 nm and approximately 1000 micrometers (μm), which may be controlled by controlling a deposition duration, as further described herein. In some other implementations, the SSE 110 may include other types of SSEs, such as one or more garnet structures, one or more perovskite structures, a thiosilicate lithium super ionic conductor (thio-LISICON) material, a solid polymer composite electrolyte, or the like.

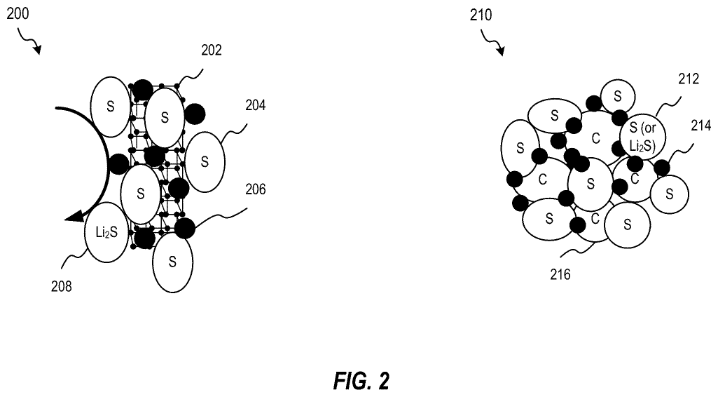

The cathode 120 may include a carbon-based conductive material, such as, for example, carbon nanotube (CNT) paper, activated carbon, porous carbon structures or carbon nanotube structures in one-dimensional (1D), two-dimensional (2D), or three-dimensional (3D) structures, carbon powder, carbon fibers, carbon nanofibers, graphite, graphene, graphene oxides, or other materials suitable for operations described herein. In some implementations, the cathode 120 includes a composite that includes carbon material in a matrix structure (e.g., a carbon matrix structure) and sulfur or lithium sulfide (Li₂S) powders. For example, CNTs, carbon nanotubes, or carbon powder may form a conductive matrix structure, and the sulfur powder or the Li₂S powder may be disposed within the conductive matrix structure. Illustrative examples of carbon matrix structures are shown herein with reference to FIG. 2. Additionally or alternatively, the cathode 120 may include a polysulfide, such as Li₂S₈, Li₂S₆, Li₂S₄, Li₂S₂, Li₂S, or a mixture thereof, as non-limiting examples.

As described above, the electrochemical energy storage system 100 provides benefits compared to conventional LIBs and Li—S batteries. For example, the 2D TMD layers 106 reduce or prevent Li-dendrite growth at the current collector 102 due to the 2D TMD material's high ion transport and uniform Li-ion deposition properties. Reducing or preventing Li-dendrite growth reduces corrosion of the electrochemical energy storage system 100 (e.g., of the current collector 102), thereby preventing (or reducing a likelihood of) safety issues for the electrochemical energy storage system 100 at higher C-rates. Because the current collector 102 is Li-metal-free, the source of Li-ions within the electrochemical energy storage system 100 is Li₂S and polysulfides in the cathode 120, the SSE 110, or both. The Li₂S and polysulfides may be trapped within the carbon matrix structure of the cathode 120, resulting in faster conversion of polysulfides, which decreases polysulfide loss due to diffusion. This decreased polysulfide loss extends the cycle life and improves energy density of the electrochemical energy storage system 100, thereby providing significant performance improvements as compared to LIBs or other Li—S batteries. Additionally, using an Li-metal-free current collector (e.g., the current collector 102) instead of a conventional lithium anode reduces the weight and cost of the electrochemical energy storage system 100.

FIG. 2 illustrates views of an example of a cathode according to one or more aspects. In some implementations, the cathode shown in FIG. 2 may include or correspond to the cathode 120 of FIG. 1. FIG. 2 depicts a molecular-structural view 200 of the cathode and a molecular-level view 210 of the cathode. Although described as a single cathode, the views 200 and 210 may correspond to different cathodes in other implementations.

In the molecular-structural view 200, the cathode includes a conductive matrix structure 202 formed from carbon (or a carbon-based material), in addition to sulfur powder (representative sulfur 204) and ion-conductive particles (representative ion-conductive particle 206) that are disposed within the conductive matrix structure 202. The conductive matrix structure 202 may be formed from a variety of carbon structures, such as CNTs, carbon nanofibers, or carbon powder, as non-limiting examples. As can be seen in FIG. 2, Li₂S 208 (or polysulfide) particles that move toward or away from the cathode during charge cycles or discharge cycles may become trapped within the conductive matrix structure 202. As illustrated in the molecular-level view 210, sulfur molecules (e.g., representative sulfur 212, which may include individual sulfur molecules and/or Li₂S molecules that provide a source of Li-ions in the anode-free structure) and ion-conductive particles (e.g., representative ion-conductive particle 214) are disposed between adjacent carbon molecules (or carbon-based material molecules, such as representative carbon molecule 216) of the conductive matrix structure 202.

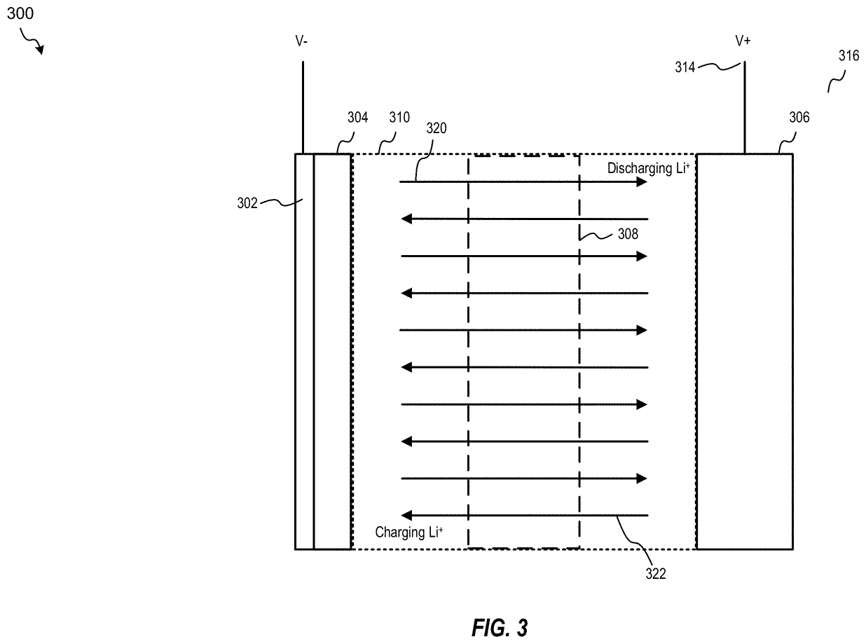

Referring to FIG. 3, an example of a battery system implemented with a 2D TMD-coated lithium metal-free current collector according to one or more aspects is shown as a battery system 300. In some implementations, the battery system 300 may include or correspond to the electrochemical energy storage system 100 of FIG. 1. In the implementation illustrated in FIG. 3, the battery system 300 (e.g., a Li—S battery (LSB) system) includes a current collector 302, a cathode 306, a separator 308, an electrolyte 310, a current collector 314, and a casing 316. The current collector 302 may be an Li-metal-free structure, for example, a collector made of Cu, Al, carbon materials, or a Li alloy, or other Li-metal-free conductive materials suitable for operations described herein. The current collector 302 may be coated with a 2D TMD layer 304 (or multiple 2D TMD layers), such as one or more layers of MoS₂, WS₂, MoTe₂, MoSe₂, WSe₂, TiS₂, TaSe₂, NbSe₂, NiTe₂, BN, or the like, as non-limiting examples. Although not illustrated, an interlayer may be disposed between the current collector 302 and the 2D TMD layer 304, similar to the interlayer 104 described with reference to FIG. 1. The cathode 306 may include CNT paper, activated carbon, porous carbon structures in 1D, 2D, or 3D structures, carbon powder, carbon fibers, carbon nanofibers, graphite, graphene, graphene oxides, or other materials suitable for operations described herein. In some implementations, the cathode 306 includes a composite that includes carbon material in a matrix structure (e.g., a carbon structure such as carbon powder, CNTs, carbon nanofibers, or the like) and sulfur or Li₂S powders.

During operation of the battery system 300, ion flow 320 illustrates the flow of discharging ions (e.g., Li+, etc.) from the current collector 302, and ion flow 322 illustrates the flow of charging ions (e.g., Li+, etc.) from the cathode 306. The separator 308 may be positioned between the current collector 302 and the cathode 306 and may include, for example, polypropylene (PP), polyethylene (PE), other materials suitable for operations discussed herein, or combinations thereof. The separator 308 preferably has pores through which ion flows 320 and 322 may pass. The electrolyte 310 may be positioned on either side of the separator 308, between the current collector 302 and the cathode 306, and may include any number of electrolyte solutions (e.g., aqueous, non-aqueous, etc.) which may allow for transporting ion flows 320 and 322 between the current collector 302 and the cathode 306. For example, the electrolyte 310 may include various lithium salts (e.g., LiPF₆, LiClO₄, LiH₂PO₄, LiAlCl₄, LiBF₄, etc.) or other electrolyte material suitable for operations discussed herein. In some implementations, the electrolyte 310 may include one or more layers of a 2D TMD material. In some other implementations, the electrolyte 310 may include a type of SSE, such as one or more garnet structures, one or more perovskite structures, a thio-LISICON material, a solid polymer composite electrolyte, or the like.

The current collector 302 may operate as (or be used as a replacement for) a conventional metallic Li anode, and the current collector 314 may be attached to cathode 306. In some implementations, the current collectors 302 and 314 may extend, through the casing 316, from an interior region of the casing 316 to an exterior region of the casing 316. Additionally, the current collectors 302 and 314 may correspond to negative and positive voltage terminals, respectively, and comprise conductive materials. As a non-limiting example, the current collector 302 may include copper metal and the current collector 314 may include aluminum metal. The casing 316 may include a variety of cell form factors. For example, implementations of the battery system 300 may be incorporated in a cylindrical cell (e.g., 13650, 18650, 18500, 26650, 21700, etc.), a polymer cell, a button cell, a prismatic cell, a pouch cell, or other form factors suitable for operations discussed herein. Further, one or more cells may be combined into larger battery packs for use in a variety of applications (e.g., cars, laptops, etc.). In certain implementations, microcontrollers and/or other safety circuitry may be used along with voltage regulators to manage cell operation and may be tailored to specific uses of the battery system 300.

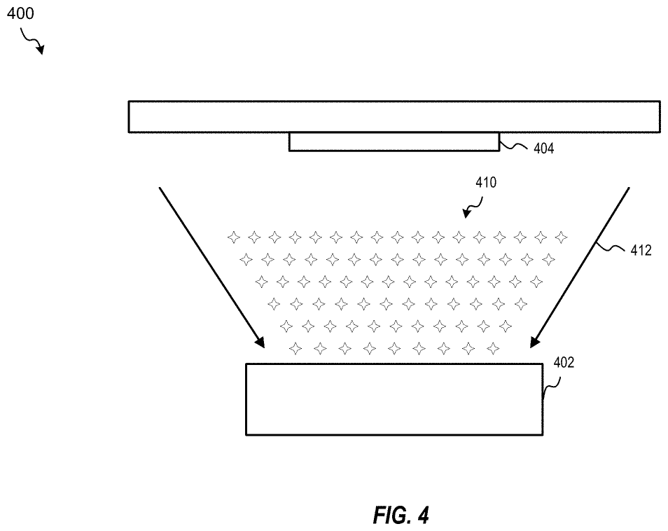

Referring to FIG. 4, a schematic for fabricating a 2D TMD-coated Li-metal-free current collector according to one or more aspects is shown a system 400. The system 400 is configured to perform a sputtering process to fabricate the 2D TMD-coated Li-metal-free current collector. In some implementations, the system 400 may be used to fabricate one or more components of the electrochemical energy storage system 100 of FIG. 1 or the battery system 300 of FIG. 3. As shown in FIG. 4, the system 400 includes a substrate 402 and target materials 404 for use during sputtering. The substrate 402 includes Li-metal free material(s), such as Cu, Al, carbon materials, or Li alloys as non-limiting examples. The target materials 404 include one or more 2D TMD materials, such as MoS₂, WS₂, MoWS₂, or any of the other 2D TMD materials described herein.

During fabrication, one or more layers of 2D TMD material (e.g., the target materials 404) may be formed on the substrate 402 by sputtering 410. In some implementations, the sputtering 410 may include forming an interlayer on the substrate 402 prior to deposition of the target materials 404. For example, the sputtering 410 may include sputtering metallic materials as an interlayer, such as, for example, Si, Ge, Sn, Pb, Sb, Al, Ti, Ta, Mo, Nb, W, Hf, Ni, Co, Cd, and/or other metals suitable for forming Li alloys when a battery is cycling. After the interlayer is formed, the sputtering 410 includes sputtering the target materials 404 on a metallic-coated surface of the substrate 402 to form one or more layers of 2D TMD material. Using the target materials 404 (e.g., any of the aforementioned materials) as the target material for magnetron radio frequency (RF) sputtering, one or more successive layers of 2D TMD material may be deposited onto a current conducting material (e.g., the substrate 402 and the optional interlayer) to produce a 2D TMD-coated current collector. In some implementations, inert gas 412 such as, for example, argon plasma or pure (99.999% purity) argon, helium, or other gases with low reactivity with other substances may be fed into the system 400 via a gas inlet valve (not depicted) during the sputtering 410. The sputtering 410 preferably occurs within the system 400 (e.g., within a chamber) at temperatures set between room temperature and approximately 500° C. In some implementations, the chamber may be evacuated, before each sputtering run, to a vacuum level of, e.g., ≤1×10⁻⁶ Torr without plasma. In some implementations, the sputtering 410 may start when an RF power of 5-100 W is applied to the target materials 404 and one or more layers of transition metals alloys are consequently deposited on the substrate 402. The sputtering duration of the sputtering 410 may be varied from 1 second to 500 seconds to adjust the thickness of the 2D TMD layer(s) deposited on the current collector (e.g., the substrate 402). For example, the sputtering duration may be controlled to result in a thickness of between approximately 1 nm and approximately 1000 nm. In some implementations, prior to deposition on the current collector, the target materials 404 may be pre-sputtered in the chamber for a pre-determined time to stabilize the deposition process. Although FIG. 4 illustrates a sputtering process, in some other implementations, the 2D TMD layer(s) may be formed (e.g., deposited) using an evaporation process or another type of deposition process.

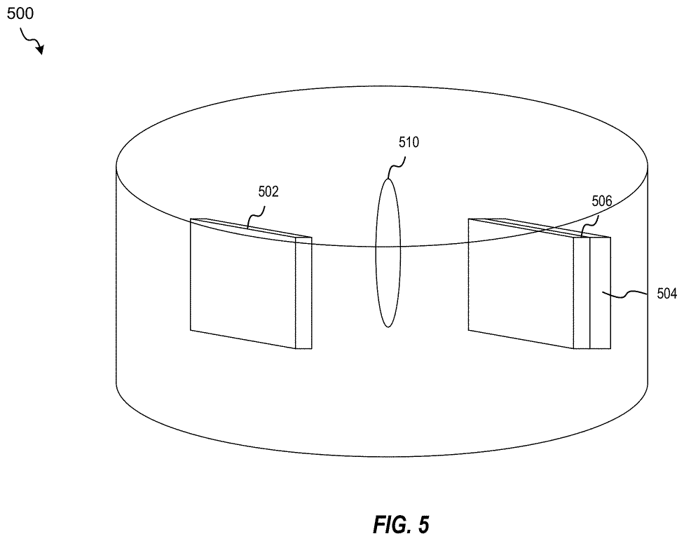

In implementations in which an SSE is to be included in a battery with the 2D TMD-coated Li-metal-free current collector and includes one or more layers of 2D TMD material, at least a portion of the SSE may be formed using the same process described above with reference to FIG. 4. For example, the 2D TMD-coated current collector formed as shown in FIG. 4 may be placed on the substrate 402, and one or more layers of 2D TMD material may be deposited on the 2D TMD-coated current collector using the sputtering 410 described above. These one or more layers of 2D TMD material may be the same or different than the 2D TMD material that coats the current collector and may serve as at least a portion of an SSE. Alternatively, at least a portion of the SSE may be formed by an evaporation process or an electrochemical deposition process, as further described herein with reference to FIG. 5. In some other implementations, the SSE includes one or more garnet structures, one or more perovskite structures, a thio-LISICON material, a solid polymer composite electrolyte, or the like, and formation of the SSE may be accomplished by slip coating or spraying the 2D TMD-coated current collector, followed by a drying and sintering process.

Referring to FIG. 5, another schematic for fabricating a 2D TMD-coated Li-metal-free current collector according to one or more aspects is shown a system 500. The system 500 is configured to perform an electrochemical deposition process to fabricate the 2D TMD-coated Li-metal-free current collector. In some implementations, the system 500 may be used to fabricate one or more components of the electrochemical energy storage system 100 of FIG. 1 or the battery system 300 of FIG. 3. As shown in FIG. 5, the system 500 includes an electrode 502 (e.g., a counter electrode), a current collector material 504, and a reference electrode 510.

During fabrication, a material to be used as a current conductor, such as Cu, Al, carbon materials, or Li alloys, as non-limiting examples, may be provided as the current collector material 504, and metal or metallic compounds or alloys may be used as the electrode 502 (e.g., the counter electrode) and the reference electrode 510. As a particular, non-limiting example, the electrode 502 may include platinum (Pt), the current collector material 504 may include Cu or a Li alloy, and the reference electrode 510 may include silver (Ag) or silver chloride (AgCl). In some implementations, an aqueous electrolyte solution, such as between approximately 1 millimol (mM) and approximately 1 mol (M) of ammonium tetrathiomolybdate ((NH₄)₂MoS₄) dissolved in de-ionized (DI) water, may be added to at least partially surround the electrode 502, the current collector material 504, and the reference electrode 510. A bias voltage, such as between 1 v/cm and 100 v/cm, may be applied to the electrode 502, the current collector material 504, and the reference electrode 510 to cause the aqueous electrolyte to reduce on a surface of the current collector material 504 to form (e.g., dispose) one or more layers of 2D TMD material 506. During at least one test run, at −1.0 v versus the reference electrode 510 (e.g., the Ag or AgCl reference), the (NH₄)₂MoS₄ in the aqueous solution starts to reduce on the carbon materials by forming MoS₄²⁻ ions, which get further reduced to a deposit of MoS₂ particles. During the at least one run, at low solution concentration of (NH₄)₂MoS₄ (e.g., 10⁻³ mM to 10³ mM), the reduction process of MoS₄²⁻ on the electrode 502 can be controlled by an applied electric field, such as from 1 v/cm to 100 v/cm. A deposition time of the process may be controlled from between 1 sec and 10 minutes to control a thickness of the one or more layers of 2D TMD material 506 (e.g., the MoS₂ film). For example, the deposition time may be controlled such that the thickness of the one or more layers of 2D TMD material 506 is between approximately 1 nm and 1000 nm.

In implementations in which an SSE is to be included in a battery with the 2D TMD-coated Li-metal-free current collector and the SSE includes one or more layers of 2D TMD material, at least a portion of the SSE may be formed using the same process described above with reference to FIG. 5. For example, the 2D TMD-coated current collector formed as shown in FIG. 5 may be placed in the system 500 (e.g., in place of the current collector material 504), and one or more layers of 2D TMD material may be deposited on the 2D TMD-coated current collector using the reduction process described above. These one or more layers of 2D TMD material may be the same or different than the 2D TMD material (e.g., the one or more layers of 2D TMD material 506) that coats the current collector and may serve as at least a portion of an SSE. Alternatively, at least a portion of the SSE may be formed by an evaporation process or a sputtering process, as further described above with reference to FIG. 4. In some other implementations, the SSE includes one or more garnet structures, one or more perovskite structures, a thio-LISICON material, a solid polymer composite electrolyte, or the like, and formation of the SSE may be accomplished by slip coating or spraying the 2D TMD-coated current collector, followed by a drying and sintering process.

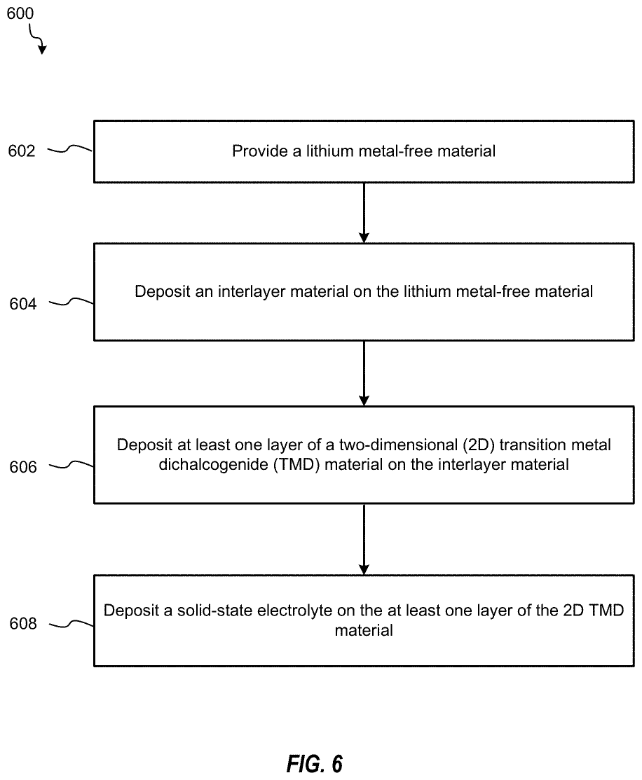

Referring to FIG. 6, a flow diagram of an example of a method for manufacturing a battery system with a 2D TMD-coated lithium metal-free current collector according to one or more aspects is shown as a method 600. In some implementations, the operations of the method 600 may be stored as instructions that, when executed by one or more processors (e.g., one or more processors of a fabrication system, which may include or correspond to the system 400 of FIG. 4, the system 500 of FIG. 5, or components thereof), cause the one or more processors to perform the operations of the method 600. In some implementations, the method 600 may be performed to manufacture a Li—S battery, such as the electrochemical energy storage system 100 of FIG. 1 or the battery system 300 of FIG. 3.

The method 600 includes providing a lithium metal-free material, at 602. For example, the Li-metal-free material may include or correspond to the current collector 102 (e.g., Cu, Al, carbon materials, or Li alloy, as non-limiting examples) of FIG. 1. The method 600 includes depositing an interlayer material on the lithium metal-free material, at 604. The interlayer material may include Si, Ge, Sn, Pb, Sb, Al, Ti, Ta, Mo, Nb, W, Hf, Ni, Co, or Cd, as non-limiting examples, and may be used to form an interlayer on the Li-metal-free material, which may include or correspond to the interlayer 104 of FIG. 1. The interlayer may improve the deposition of Li on the current collector during battery cycling. In some implementations, forming the interlayer is optional. The method 600 includes depositing at least one layer of a 2D TMD material on the interlayer material (or the lithium metal-free material if the interlayer is omitted), at 606. For example, the at least one layer of the 2D TMD material may include or correspond to the 2D TMD layers 106 of FIG. 1. The method 600 includes depositing a solid-state electrolyte on the at least one layer of the 2D TMD material, at 608. For example, the solid-state electrolyte may include or correspond to the SSE 110 of FIG. 1.

In some implementations, depositing the at least one layer of the 2D TMD material may include at least one of sputtering and evaporation. For example, the sputtering may include or correspond to the sputtering 410 of FIG. 4. In some such implementations, the sputtering uses Ar plasma, as described with reference to FIG. 4. Additionally or alternatively, the sputtering may be performed between room temperature and 500° C., as described with reference to FIG. 4. Additionally or alternatively, a deposition power of the sputtering may be between 5-100 W and a deposition time of the sputtering may be between 1-500 seconds, and the at least one layer of the 2D TMD material may have a thickness of approximately 1 nm to approximately 1000 nm, as described with reference to FIG. 4.

In some implementations, the solid-state electrolyte includes one or more layers of a 2D TMD material. In some such implementations, depositing the solid-state electrolyte includes at least one of sputtering, evaporation, or electrochemical deposition. For example, the sputtering may include or correspond to the sputtering 410 of FIG. 4, or the electrochemical deposition may include or correspond to the electrochemical deposition process described with reference to FIG. 5. In some such implementations, the one or more layers of the 2D TMD material have a thickness of approximately 1 nm to approximately 200 μm.

In some implementations, the solid-state electrolyte includes one or more garnet structures, one or more perovskite structures, a thio-LISICON material, or a solid polymer composite electrolyte. In some such implementations, depositing the solid-state electrolyte includes slip-coating or spraying the solid-state electrolyte on the at least one layer of the 2D TMD material, and performing a drying and sintering process on the solid-state electrolyte.

In some implementations, the method 600 may further include providing a cathode, forming a matrix structure from a carbon material on the cathode, depositing sulfur powder or Li₂S powder on the matrix structure, and disposing the cathode in physical contact with the solid-state electrolyte. For example, the cathode may include or correspond to the cathode 120 of FIG. 1. The cathode may include (or have formed thereon) a conductive matrix structure of carbon material, such as the conductive matrix structure 202, as further described above with reference to FIG. 2. Additionally or alternatively, the cathode may include a polysulfide, such as Li₂S₈, Li₂S₆, Li₂S₄, Li₂S₂, Li₂S, or a mixture thereof, as non-limiting examples.

As described above with reference to FIG. 6, the method 600 may enable manufacture of a battery (e.g., a Li—S battery) that includes a Li-metal-free current collector instead of a metallic Li anode. Such a battery may experience reduced Li-dendrite growth and provide improved battery performance, such as enhanced cycle life and energy density, as compared to other Li—S batteries or LIB s.

Experimental Testing of 2D TMD-Coated, Li-Metal-Free Current Collectors

The following describes experimental implementations of 2D TMD-coated, Li-metal-free current collectors for use in Li—S batteries. The discussion further illustrates possible performance advantages afforded by the 2D TMD-coated, Li-metal-free current collectors, and batteries including the same, according to aspects described herein. It should be appreciated by those skilled in the art that the present application is not intended to be limited to the particular experimental implementations and results described below.

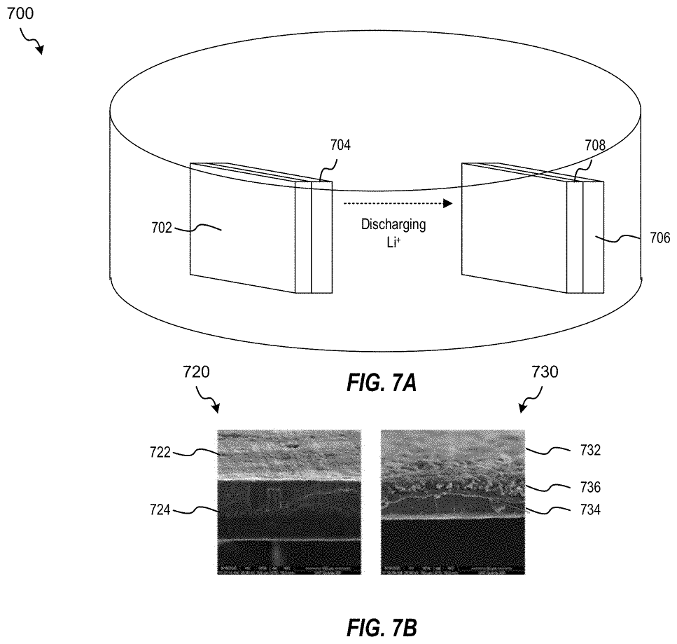

In an experimental implementation, an Li-metal-free current collector is formed from Cu and coated in MoS₂ (e.g., a 2D TMD material). The MoS₂-coated Cu current collector is displaced within a half-cell for performing symmetric cell tests. The MoS₂-coated Cu current collector is configured as a Li-metal-free anode, and the half-cell includes a counter electrode formed from MoS₂-coated Li. A schematic illustration for a symmetric cell test during discharge cycling according to one or more aspects is provided in FIG. 7A. FIG. 7A illustrates a half-cell 700 that includes a counter electrode 702 (e.g., Li+metal), a MoS₂ coating 704 (e.g., one or more layers of a 2D TMD material), a current collector 706 (e.g., Cu metal), and a MoS₂ coating 708 (e.g., one or more layers of a 2D TMD material). Prior to testing, the MoS₂ coating 708 is uniformly, or substantially uniformly, distributed on the current collector 706. During discharge cycling, as shown in FIG. 7A, Li metal is reduced from the counter electrode 702 and moves to the MoS₂-coated Cu for storage between the MoS₂ coating 708 and the current collector 706. After discharging, a thickness of the Li metal of the counter electrode 702 may be reduced from approximately 120 μm to approximately 110 μm, and the Li metal stored between the MoS2 coating 708 and the current collector 706 may increase from 0 μm (e.g., the combination of the MoS₂ coating 708 and the current collector 706 is initially Li-metal-free) to approximately 10 μm. FIG. 7B shows a scanning electron microscopy (SEM) image 720 of the counter electrode 702 and the MoS₂ coating 704 and an SEM image 730 of the current collector 706 and the MoS₂ coating 708 after the discharge cycling. The SEM image 720 includes a side view 722 of MoS₂ and a side view 724 of Li, and the SEM image 730 includes a side view 732 of MoS₂, a side view 734 of Cu, and a side view 736 of transferred Li. In the example of FIG. 7B, the side view 736 of transferred Li has a thickness of approximately 10 μm.

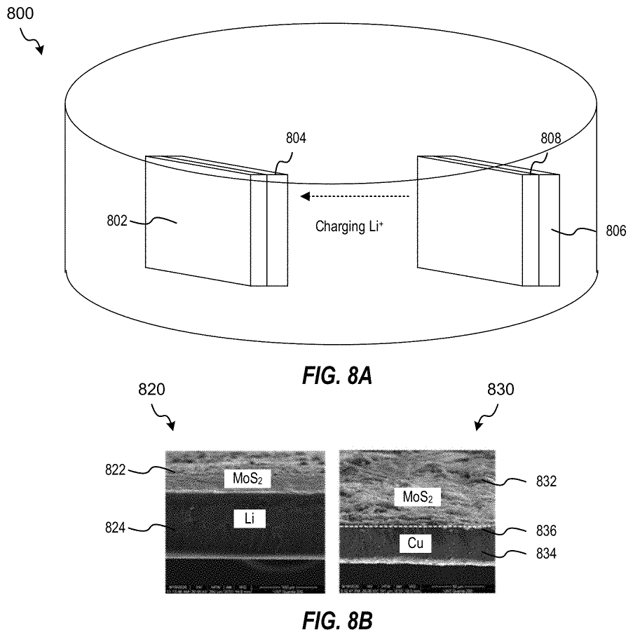

A schematic illustration for a symmetric cell test during charge cycling according to one or more aspects is provided in FIG. 8A. FIG. 8A illustrates a half-cell 800 that includes a counter electrode 802 (e.g., Li⁺ metal), a MoS₂ coating 804 (e.g., one or more layers of a 2D TMD material), a current collector 806 (e.g., Cu metal), and a MoS₂ coating 808 (e.g., one or more layers of a 2D TMD material). As described above with reference to FIGS. 7A-7B, after discharge cycling, approximately 10 μm of Li metal is stored between the MoS₂ coating 808 and the current collector 806. During charge cycling, as shown in FIG. 8A, the stored Li metal is returned to the counter electrode 802. After charging, a thickness of the Li metal of the counter electrode 802 increases from approximately 110 μm to approximately 120 μm, and the Li metal stored between the MoS₂ coating 808 and the current collector 806 is removed (e.g., the thickness is substantially 0 μm). FIG. 8B shows a SEM image 820 of the counter electrode 802 and the MoS₂ coating 804 and a SEM image 830 of the current collector 806 and the MoS₂ coating 808 after the charge cycling. The SEM image 820 includes a side view 822 of MoS₂ and a side view 824 of Li (which has returned to a thickness of approximately 120 μm), and the SEM image 830 includes a side view 832 of MoS₂, a side view 834 of Cu, and a side view 836 of stored Li (which is reduced to substantially 0 μm/is substantially removed).

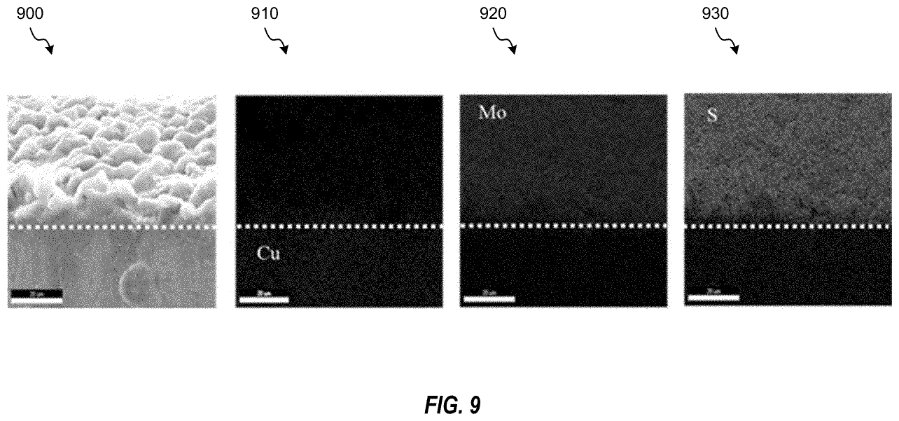

FIG. 9 illustrates images of the 2D TMD-coated, Li-metal-free current collector (e.g., the MoS₂-coated Cu of FIGS. 7A-8B) after multiple discharge cycles. In the particular example of FIG. 9, the multiple discharge cycles include at least ten discharge cycles. As shown in FIG. 9, a cross-sectional SEM image 900 of the MoS₂-coated Cu illustrates the structural differences between the layers of Li+, MoS₂, and Cu. During subsequent discharge and charge cycles, the thickness of the Li returns to approximately the initial thickness, such as varying between approximately 118 μm and approximately 105 μm, at the MoS₂-coated Cu, removing (e.g., substantially removing) the Li metal stored at the MoS₂-coated Li. FIG. 9 also includes an energy-dispersive X-ray spectroscopy (EDS) image 910 of the Cu, an EDS image 920 of the Mo, and an EDS image 930 of the S in the MoS₂-coated Cu. During at least the first ten discharge and charge cycles, the MoS₂ film remains stable (e.g., a thickness remains substantially the same) on the Cu and Li metal.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A battery comprising:
a lithium metal-free current collector coated with at least one layer of a two-dimensional (2D) transition metal dichalcogenide (TMD) material;
a cathode; and
a solid-state electrolyte in physical contact with both the at least one layer of the 2D TMD material and the cathode.

2. The battery of claim 1, wherein the lithium metal-free current collector comprises a copper metal collector or an aluminum metal collector.

3. The battery of claim 1, wherein the lithium metal-free current collector comprises a lithium alloy collector.

4. The battery of claim 1, wherein the at least one layer of the 2D TMD material includes at least one layer selected from: molybdenum disulfide (MoS₂), tungsten disulfide (WS₂), molybdenum ditelluride (MoTe₂), molybdenum diselenide (MoSe₂), tungsten diselenide (WSe₂), titanium disulfide (TiS₂), tantalum disulfide (TaSe₂), niobium diselenide (NbSe₂), nickel ditelluride (NiTe₂), boron nitride (BN), molybdenum tungsten disulfide (MoWS₂), molybdenum tungsten ditelluride (MoWTe₂), molybdenum sulfur ditelluride (MoSTe₂), molybdenum sulfur diselenide (MoSSe₂), molybdenum rhenium disulfide (MoReS₂), niobium tungsten disulfide (NbWS₂), vanadium molybdenum ditelluride (VMoTe₂), tungsten sulfur diselenide (WSSe₂), tungsten tellurium disulfide (WTeS₂), and tin selenium disulfide (SnSeS₂).

5. The battery of claim 1, further comprising an interlayer disposed between the lithium metal-free current collector and the at least one layer of the 2D TMD material.

6. The battery of claim 5, wherein the interlayer includes metal particles or one or more thin films selected from magnesium (Mg), silver (Ag), zinc (Zn), aluminum (Al), carbon (C), silicon (Si), tin (Sn), lead (Pb), antimony (Sb), bismuth (Bi), molybdenum (Mo), tellurium (Te), tantalum (Ta), and titanium (Ti).

7. The battery of claim 1, wherein the solid-state electrolyte comprises one or more garnet structures, one or more perovskite structures, a thiosilicate lithium super ionic conductor (thio-LISICON) material, or a solid polymer composite electrolyte.

8. The battery of claim 1, wherein the solid-state electrolyte comprises one or more layers of a 2D TMD material.

9. The battery of claim 1, wherein the cathode includes a carbon matrix structure having sulfur powder or lithium sulfide (Li₂S) powder disposed within.

10. The battery of claim 9, wherein the carbon matrix structure comprises a plurality of carbon nanotube structures, a plurality of carbon nanofibers, or carbon powder.

11. The battery of claim 9, wherein the cathode further comprises a polysulfide including Li₂S₈, Li₂S₆, Li₂S₄, Li₂S₂, Li₂S, or a combination thereof.

12. A method comprising:
providing a lithium metal-free material;
depositing at least one layer of a two-dimensional (2D) transition metal dichalcogenide (TMD) material on the lithium metal-free material; and
depositing a solid-state electrolyte on the at least one layer of the 2D TMD material.

13. The method of claim 12, wherein the depositing the at least one layer of the 2D TMD material includes at least one of sputtering and evaporation.

14. The method of claim 13, wherein the sputtering uses Argon (Ar) plasma.

15. The method of claim 13, wherein the sputtering is performed between room temperature and 500° C.

16. The method of claim 13, wherein a deposition power of the sputtering is between 5-100 watts (W) and a deposition time of the sputtering is between 1-500 seconds, and wherein the at least one layer of the 2D TMD material has a thickness of approximately 1 nanometer (nm) to approximately 1000 nm.

17. The method of claim 12, wherein the solid-state electrolyte comprises one or more layers of a 2D TMD material, and wherein the depositing the solid-state electrolyte comprises at least one of sputtering, evaporation, or electrochemical deposition.

18. The method of claim 17, wherein the one or more layers of the 2D TMD material have a thickness of approximately 10 nanometers (nm) to approximately 200 micrometers (μm).

19. The method of claim 12, wherein the solid-state electrolyte comprises one or more garnet structures, one or more perovskite structures, a thiosilicate lithium super ionic conductor (thio-LISICON) material, or a solid polymer composite electrolyte, and wherein the depositing the solid-state electrolyte comprises:
slip-coating or spraying the solid-state electrolyte on the at least one layer of the 2D TMD material; and
performing a drying and sintering process on the solid-state electrolyte.

20. The method of claim 12, further comprising:
providing a cathode;
forming a matrix structure from a carbon material on the cathode;
depositing sulfur powder or lithium polysulfide (LiS) powder on the matrix structure; and
disposing the cathode in physical contact with the solid-state electrolyte.
